(19) United States
(12) Patent Application Publication
(10) Pub. No.: US 2004/0262126 A1
(43) Pub. Date: Dec. 30, 2004

(54) Device for changing position through turning of individual or stacked products conveyed along a conveying path

(75) Inventor: Erik Vind Nielsen, Esbjerg (DK)

Correspondence Address: VENABLE, BAETJER, HOWARD AND CIVILETTI, LLP, P.O. BOX 34385, WASHINGTON, DC, 20043-9998, US

(73) Assignee: Muller Martini Holding AG, Hergiswil (CH)

(21) Appl. No.: 10/875,789

(22) Filed: Jun. 25, 2004

(30) Foreign Application Priority Data
Jun. 27, 2003 (EP) 03405477.5

(51) Int. Cl. B65G 47/244

(52) U.S. Cl. 198/379

(57) ABSTRACT

A device for changing the position, by turning, of individual or stacked products conveyed along a transport path, has a conveyor for conveying the products along the transport path, a turning device arranged along the transport path for turning the products around an axis perpendicular to the conveying direction. The turning device is attached to a traversing stand that can be moved along a conveying section of the conveyor that is defined by laterally spaced conveying belts. In the conveying section, the conveying belts form a loop that extends downward, perpendicular to the conveying direction, being guided around deflection rollers on the traversing stand.

### CROSS-REFERENCE TO RELATED APPLICATION

This application claims the priority of European Patent Application No. 03405477.5, filed on Jun. 27, 2003, the subject matter of which is incorporated herein by reference.

### BACKGROUND OF THE INVENTION

The invention relates to a device for changing the position, by turning, of individual or stacked products, conveyed along a conveying path, the device comprising a conveyor for conveying the products along a transport path, as well as a turning device, arranged along the conveying path, for turning the products around an axis that is perpendicular to the conveying direction. The turning device is attached to a traversing stand, or movable support, that can be moved along a conveying section of the conveyor that is formed by conveying belts spaced laterally from one another.

A so-called turning station by the company SOLEMA S.n.C., Via Carducci 18, 24066 Pedrengo-BG, Italy, is known for reorienting either individual products or a stack consisting of individual products, in a product flow, by turning them around an axis that is perpendicular to the movement direction of the product flow, such that the products can be fed, for example, properly oriented to a palletizing device. With this turning station, the products are supplied by two laterally-spaced conveying belts displaced to a turning device between the conveying belts, the turning device having a rotatingly driven support plate and a freely rotating pressure plate that can be lowered and is disposed at a distance above the support plate.

As soon as the products to be turned reach the turning station, the support plate is raised, the pressure plate is lowered and the clamped product or product stack is turned. For this operation, the conveying belts that form a conveying section are spaced apart far enough that the products located in-between sag on the underside. If the spacing between the conveying belts is changed due to a product format change and to obtain more favorable turning conditions for the products, the support plate must be replaced, thus requiring conversion operations and a basic supply of several support plates with different diameters.

### SUMMARY OF THE INVENTION

It is therefore the object of the present invention to provide a simple device that considerably reduces the operational steps required in the region of the turning station during a product format change.

This object is achieved by the invention by conveying sections of the conveying belts forming a conveying element being guided around deflection rollers which are rotatably positioned on the traversing stand, thus permitting a loop to form which extends downward, perpendicular to the conveying direction.

It has proven advantageous if the lateral spacing between the conveying belts remains unchanged during adaptation to different product formats.

The turning device attached to the traversing stand preferably comprises a lifting device for lifting the products above the conveying section of the conveying belts, as well as an oppositely-arranged, and/or above-arranged, rotatingly driven pressure plate that presses the products against the lifting element, such that a precise change in the product position can be realized during the turning operation.

The lifting device advantageously takes the form of a lifting element which can be rotated and can be moved upward from a starting position below the conveying section and/or the loops of the conveying section and the space between the conveying belts to an operating position above the conveying sections.

To avoid having to make changes to the rotating device during a change in product format, it is advantageous if the lifting element is configured as a capstan of two crossing support bars, such that the lifting element in the starting position is positioned with one support bar between the conveying belts and with the other support bar crosswise to the conveying direction, inside the loops of the conveying section of the conveying belts.

That is to say, during a position change of the products by 90° or 180°, the support bar that is aligned in the starting position between the conveying belts will be located in the loops of the conveying section following the rotation.

The pressure unit can be provided with a counter-pressure plate, driven to move up and down in a perpendicular direction, or a different element that can exert a counter pressure.

The lifting element and the counter-pressure plate can advantageously be driven jointly for changing the position of the products, wherein either the lifting element or the counter-pressure plate can freely rotate, or both can be driven at the same speed.

The traversing stand preferably is driven forward and back along the conveying element, which allows the products to be gripped, turned and deposited again with a speed that is synchronized with speed of the conveying section.

The return speed for gripping additional products at the front end of the conveying element can be higher than the conveying speed during the turning of the products.

A continuous processing can thus be realized with the proposed device.

The proposed device further distinguishes itself in that a motor for moving the traversing stand along the conveying element, the driven lifting element, and the pressure unit are effectively connected to a control on its transmitting side, so that an uninterrupted process can be realized.

Accordingly, the control is connected on its receiving side with upstream installed sensors installed on the upstream side of the device to detect the height and arrival of the products at the conveying element and to ensure a reliable operation of the device.

### BRIEF DESCRIPTION OF THE DRAWINGS

The invention is explained in the following with the aid of an exemplary embodiment and reference to the drawing for all details not further explained in the specification the drawing showing in:

FIG. 1 a longitudinal section through the device along the line I-I in FIG. 2;

FIG. 2 a view of the device along arrow II in FIG. 1; and

FIGS. 3A-3G a sequence of processing steps and/or the mode of operation of the device.

### DETAILED DESCRIPTION OF THE INVENTION

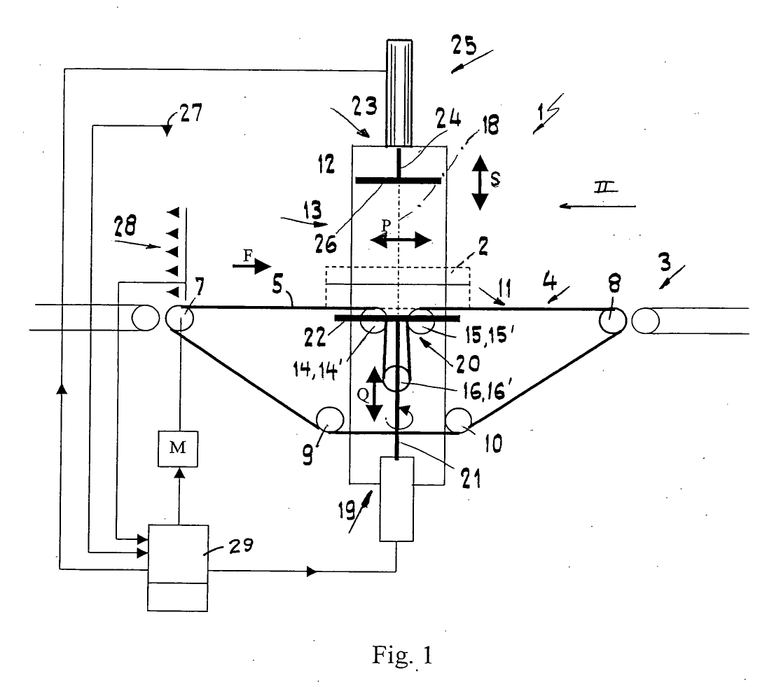

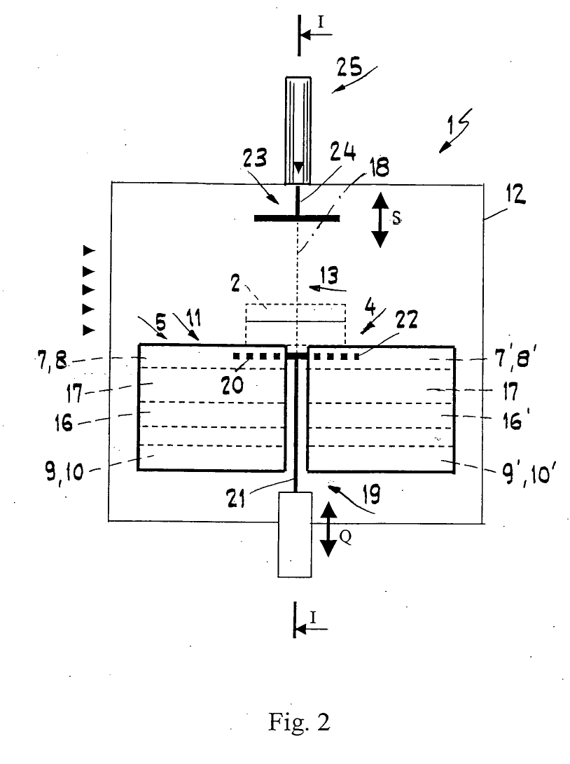

FIGS. 1 and 2 show a device 1 for changing the position, by turning, of products 2 which are supplied individually or stacked. The products 2 are stackable magazines, brochures, books, workpieces or the like. The device 1 is arranged along a transport path formed by a conveyor 3 and is provided with an associated conveying section of the conveyor 3. The conveying direction for the products and/or the product stacks 2 is indicated by arrow F. The conveying section is designed as a conveying element 4 and is driven by an electric motor M.

The conveying element 4 consists of at least two adjacent conveying belts 5, 6, arranged at a distance from each other, which circulate around, respectively, two conveying rollers 7, 7′; 8, 8′ and two tensioning rollers 9, 9′; 10, 10′. The conveying belts 5, 6, having a joint conveying width that corresponds approximately to that of the conveyor 3, form a conveying section 11 that moves in the conveying direction F through a traversing stand 12 to which a turning device 13 is attached.

On the traversing stand 12, which can be driven to move along the stationary conveying element 4 in the conveying direction F from the front conveying end to the back conveying end and back, two deflection rollers 14, 14′; 15, 15′ and one loop roller 16, 16′ are respectively positioned on the sides of the conveying element 4 in a triangular arrangement, such that a loop 17, 17′ forms that has constant length and can be displaced with the traversing stand 12 along the conveying element 4. The loop 17, 17′ is oriented approximately at a right angle to the conveying section of conveying belts 5, 6 in a downward direction. The reversible movement of the traversing stand 12 is shown with a double arrow P in FIG. 1.

The speed of the traversing stand 12 in the conveying direction F corresponds to the conveying speed of the conveying section 11 of conveying belts 5, 6, so that the products 2 can be picked up while being transported and while the speed of conveying section 11 and traversing stand 12 is synchronized and can be lifted up and turned by the turning device 13.

A lifting device 19 is connected to the traversing stand 12 below the conveying section 11, between the conveying belts 5, 6, to change the position of products 2 around an axis that is perpendicular to the movement direction F. This lifting device is provided with a lifting element 20 which can be lifted and lowered to be above or below the conveying section 11. The lifting element 20 is provided with support bars 22 that cross at a right angle to a support surface at the upper and/or exposed end of a pneumatic or electromechanical lifting rod 21, which moves up and down, as indicated by the double arrow Q. One of these support bars extends between the conveying belts 5, 6 in the conveying direction F, while the other one extends inside the loops 17, 17′ and/or crosswise to the conveying direction F in a horizontal orientation. A pressure unit 23 that is effective in a counter direction is installed on the traversing stand 12, opposite the lifting device 19, above the conveying section 11 and/or the conveying sections of conveying belts 5, 6. This pressure unit is provided with a pressure plate 26 that is attached to a piston 24 of a pneumatic piston-cylinder unit 25 and can be lifted and lowered in the direction of double arrow S. The pressure plate 26 presses onto the top of the products 2 before the turning movement of the capstan and/or the lifting element 20 is initiated. The pressure plate 26 is positioned so as to turn freely about the axis 18 or such that it can be driven with the capstan. In the latter case, the lifting element 20 and the pressure plate 26 operate jointly and at the same speed as one another when turning the products 2.

The traversing stand 12, with the attached lifting device 19 and the pressure unit 23, is driven in the conveying direction F at the speed of the conveying section 11, so that the turning operation can be realized while the products 2 are conveyed along. Once they pass by a sensor 27 that detects the presence of a product 2 and a height sensor 28 that measures the height of a product 2 or a product stack, the products 2 are gripped and turned to the desired position by the lifting element 20 of lifting device 19 that has been driven upward to be above the conveying section 11 and by the pressure plate 26 that is lowered to the height of the product or product stack 2. In the process, the lifting element 20 can assume a position at a constant distance above the conveying section 11 for turning the product 2. Following the turning, the lifting element 20 and the pressure plate 26 separate from the products 2, wherein the separation can be achieved simply by lowering the lifting element 20. Before the lifting element 20 reaches the starting position below the conveying section 11, the products 2 are again picked up by the conveying section 11 and transported further. The sensors 27, 28 are connected to a control 29 that is supplied by a programmed computer 30 with data for operating the conveying element 4, the traversing stand 12, the lifting and/or turning device 19 and the pressure unit 23.

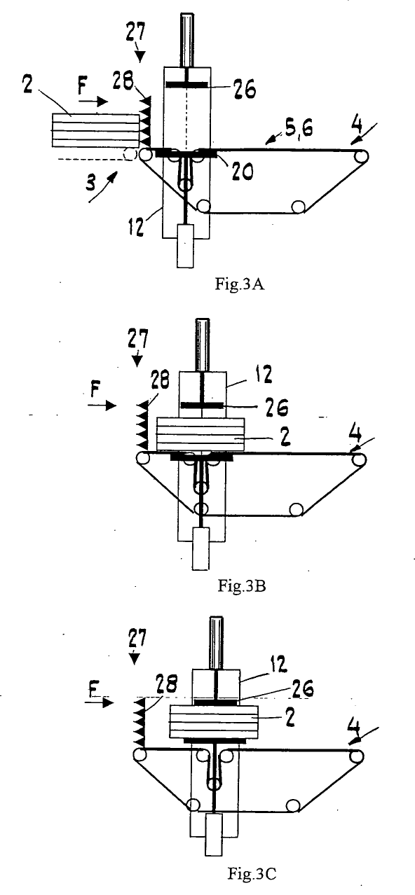

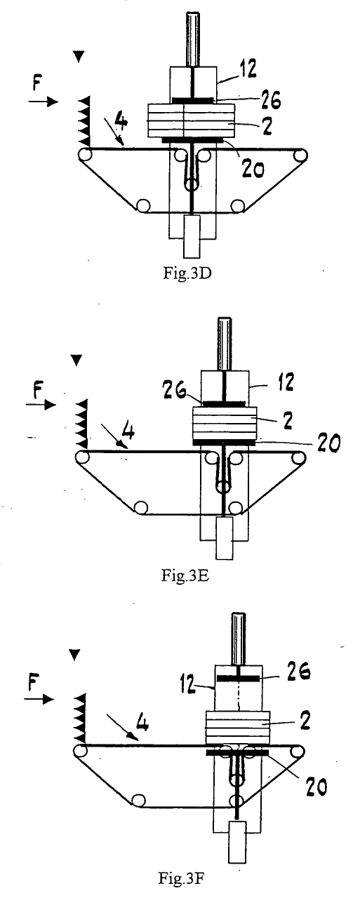

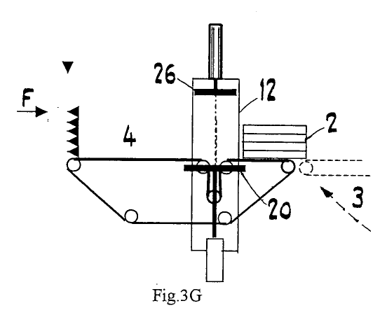

FIG. 3A shows a first sequence of processing steps carried out with the device 1. The product stack 2, transported on the conveyor 3 in the conveying direction F, reaches the sensors 27, 28, installed upstream of the conveying element 4, that detect the presence and height of the stack. In FIG. 3A, the device 1 is in a starting position in which the traversing stand 12 is positioned at the front end of the conveying element 4, the lifting element 20 is positioned below the conveying section 11, and the pressure plate 26 is positioned above the maximum and/or effective stack height. The conveying belts 5, 6 of the conveying element 4 circulate at the conveying speed of the conveyor 3.

FIG. 3B shows that the product stack 2 has reached the traversing stand 12 and can be picked up by the turning device. The pressure plate 26 is then lowered further, and the lifting element 20 raised until it is above the conveying section 11.

As soon as the height of a product 2 or the product stack has been detected by the sensor 28, the pressure unit 23 adjusts the pressure plate 26 to a height where a short lift is sufficient for the contact with the top of a product 2 or product stack.

According to FIG. 3C, the lifting element 20 is positioned above the conveying section 11, and the pressure plate 26 has reached the top of the product stack 2. The traversing stand 12 has meanwhile moved forward in the conveying direction F.

As shown in FIG. 3D, a turning operation around a perpendicular axis is subsequently realized during the further transport, so that the product stack 2 assumes a position that is changed by 90°, as shown in FIG. 3E.

The lifting element 20 and the pressure plate 26 are then separated from the product stack 2, and the conveying element 4 takes over the further transport of the product stack (FIG. 3F).

The stack of products 2 subsequently leaves the conveying element 4 on the conveyor 3 (FIG. 3G) while, at the same time, the traversing stand 12 is moved back to the starting position shown in FIG. 3A.

The traversing stand 12 can thus be moved completely independent of the drive for the conveying element 4.

The invention has been described in detail with respect to exemplary embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A device for changing the position, by turning, of products, both individual and stacked, conveyed along a transport path, comprising
a conveyor conveying the products in a conveying direction along a transport path, the conveyor having a conveying section defined by conveying belts that are spaced laterally from one another;
a turning device, arranged along the transport path, for turning the products around an axis that is perpendicular to the conveying direction; and
a traversing stand traversable along said conveying section of the conveyor,
wherein the turning device is attached to the traversing stand; the conveying belts defining the conveying sections define a conveying element, each conveying belt forming a loop that extends downward, perpendicular to the conveying direction; and the conveying belts are guided around deflection rollers that are rotatably positioned on the traversing stand.

2. The device according to claim 1, wherein the lateral spacing of the conveying belts from one another is fixed.

3. The device according to claim 1, wherein the turning device comprises a lifting device and an oppositely-arranged, driven pressure unit.

4. The device according to claim 3, wherein the lifting device has a lifting element and an arrangement driving the lifting element for turning and adjustment in height from a starting position below the conveying section to an operating position above the conveying section.

5. The device according to claim 4, wherein the lifting element is a capstan formed with two crossing support bars, one of the support bars being positioned between the conveying belts and extending parallel to the conveying direction, when the lifting element is in a starting position, and the other support bar being positioned crosswise to the conveying direction, inside the loops.

6. The device according to claim 3, wherein the pressure unit has a counter-pressure plate drivable perpendicular to the conveying direction.

7. The device according to claim 6, wherein the lifting element and the counter-pressure plate are drivable to rotate jointly.

8. The device according to claim 1, wherein the traversing stand is drivable back and forth along the conveying element.

9. The device according to claim 1, wherein an electric motor for moving the traversing stand along the conveying element, the lifting element that is attached to the traversing stand, and the pressure unit are connected to outputs of a joint control.

10. The device according to claim 9, wherein inputs of the joint control are connected to the conveying element and to sensors, upstream of the traversing stand, that detect the height and time of arrival of the products.
